(19) United States
(12) Patent Application Publication
(10) Pub. No.: US 2006/0187779 A1
(43) Pub. Date: Aug. 24, 2006

(54) Device and method for recording data blocks

(76) Inventor: Johannis Friso Rendert Blacquiere, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/566,766

(22) PCT Filed: Jul. 9, 2004
(86) PCT No.: PCT/IB04/02499

§ 371 Date: Jan. 31, 2006

(30) Foreign Application Priority Data
Aug. 4, 2003 (EP) 03300080.3

(51) Int. Cl. G11B 5/09

(52) U.S. Cl. 369/47.1

(57) ABSTRACT

The present invention relates to a method for recording at least one data block on a disc-shaped record carrier (11). Said method comprises the steps of moving a write head towards a predetermined track comprising a first location (M) to which the at least one data block is planned to be written. It also comprises a step of determining a current location (I) of the write head on the track. It finally comprises a step of determining a second location (J), which is the nearest available location on the track of the current location of the write head in the rotational sense of the record carrier, and of writing said at least one data block to said second location.

### FIELD OF THE INVENTION

The present invention relates to a method for recording data blocks having logical address in a storage space on a record carrier.

The present invention also relates to a device for recording data blocks, said device implementing such a recording method.

It finally relates to a computer program product for recording data blocks.

This invention is, for example, relevant in the field of physically organizing recorded data in recording systems, and in particular to defect management when recording real-time information such as video.

### BACKGROUND OF THE INVENTION

Optical drives have a relative low performance compared to hard disk drives. One of the main differences is the access performance, which is considerably lower than the access performance of hard disk drives. The access performance of an optical drive is mainly determined by mechanical factors such as the optical pick-up unit movement, the disc rotational speed adaptation and rotational delay.

The rotational delay is the time it takes for the laser spot to reach the start of the desired location on a track after the laser spot has reached that specific track. This means that the rotational delay has a value between zero and the maximum time of a single disc rotation. On average this rotational delay will be equal to one half of the total rotation time.

A conventional optical recording device implements various steps in order to write to a certain physical location on an optical disc. To this end, said recording device is controlled via an interface by a host system.

During a first step, the host system gives a write command for a predetermined logical address. This logical address is converted into a physical address in the optical recording device. The second step occurs in optical recording devices that have some kind of defect management, based on, for example, the Mount Rainier standard or any equivalent standard. An optical record carrier implementing such a defect management system comprises at least one table area, which contains the defect tables of said record carrier, a user data area, which is an area of the record carrier that can be used by the file management system, i.e. the user, and at least one defect management area, which is a replacement area when some parts of the user data area are defective.

During the second step, a logical address X is converted into a physical address Y. If the physical address Y is defective however, it is replaced by a physical address M that belongs to one of the defect management areas on disc. This effectively means that if a host system wants to read the data from logical address X, the data from physical address M is returned.

This mode of operation is not always efficient in terms of access performance. FIG. 1 illustrates this point by showing the actual layout, i.e. a spiral track form, of an optical disc. Let us suppose that a data block has to be written to the physical address M, and that the optical disc is rotated such that the laser spot is at a physical address L when the optical pick-up unit radial movement is completed and when the corresponding laser spot is on the desired track. If the recording device has to write to the physical address M, said device has to wait almost an entire rotation before said physical address M is reached. Moreover, the optical pick-up unit has to perform also a small jump backwards of one track during this rotation.

### SUMMARY OF THE INVENTION

It is an object of the invention to propose a device and method for recording at least one data block on a disc-shaped record carrier, which is able to increase the access performance compared to the prior art, by minimizing the delay caused by the rotational delay.

To this end, the recording method in accordance with the invention is characterized in that it comprises the steps of:

moving a write head towards a predetermined track comprising a first location at which the at least one data block is planned to be written,

determining a current location of the write head on the track,

determining a second location, which is the nearest available location on the predetermined track of the current location of the write head in the rotational sense of the record carrier,

writing said at least one data block to said second location.

The present invention also relates to a recording device comprising:

a head for writing at least one data block on said record carrier,

means for moving the write head towards a predetermined track comprising a first location at which the at least one data block is planned to be written,

means for determining a current location of the write head when it is positioned on the predetermined track, and

means for controlling the write head in such a way that the at least one data block is written to a second location, which is the nearest available location on the predetermined track of the current location of the write head in the rotational sense of the record carrier.

As a consequence, the at least one data block is written to a physical address J, instead of being written to its originally planned physical address M. The advantage of such a recording mechanism is that it saves about half the rotation time, where rotation time is in the order of 25 to 60 milliseconds in the case of optical recording.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows the spiral track structure of data blocks on a disc-shaped record carrier,

FIG. 2 is a block diagram of a recording method in accordance with a first embodiment of the invention, and

FIG. 3 is a block diagram of a recording device for writing information on a record carrier.

### DETAILED DESCRIPTION OF THE INVENTION

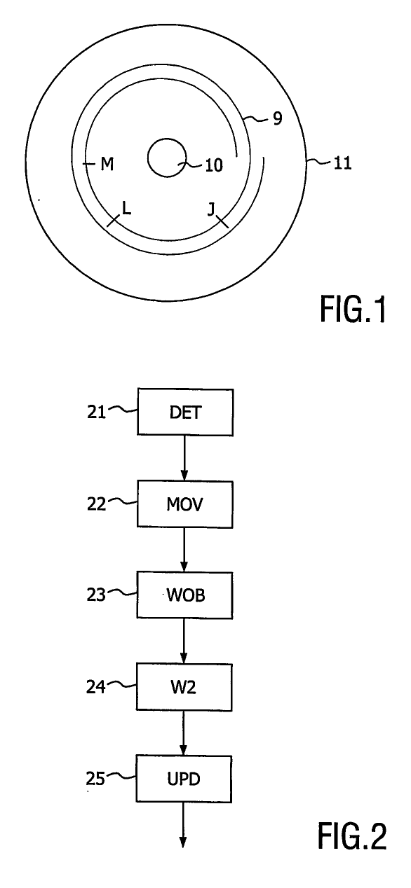

FIG. 1 shows a disc-shaped record carrier 11 having a track 9 and a central hole 10. The track 9 is the position of the series of to be recorded marks representing information. Said track is arranged in accordance with a spiral pattern of turns constituting substantially parallel tracks on an information layer. The record carrier may be optically readable, called an optical disc, and has an information layer of a recordable type. Examples of recordable discs are the CD-R and CD-RW, and writable versions of DVD, such as DVD+R or DVD+RW, and the high density writable optical discs using blue lasers, called Blu-ray discs BD. The information is represented on the information layer by recording optically detectable marks along the track, for example crystalline or amorphous marks in phase change material. The track 9 on the recordable type of record carrier is indicated by a pre-embossed track structure provided during manufacture of the blank record carrier. The track structure is constituted, for example, by a pre-groove, which enable read/write head to follow the track during scanning. The track structure comprises position information including so-called physical addresses, for indicating the location of units of information, usually called data blocks.

It will be apparent to a person skilled in the art that the present invention is not limited to optical recording device but may be also applied to other type of recording device, such as magnetic recording device for example, based on the fact that information are stored according to a rotational manner, e.g. in a spiral or in circles with different radii.

The record carrier is intended for carrying digital information in blocks under control of a file management system. The information includes real-time information to be recorded and reproduced continuously, in particular information representing digitally encoded video according to a standardized format like MPEG2, for example.

FIG. 2 is a block diagram depicting a first embodiment of a recording method in accordance with the invention. Said recording method is described in the case of defect management and is based on the fact that the record carrier comprises:

a user area for storing data blocks,

a defect management area for storing data blocks corresponding to defective locations in the user area, and

a table area for storing a correspondence between logical addresses of data blocks and their location in the defect management area in defect management tables.

For example, said record carrier is based on the Mount Rainier standard or an equivalent standard such as the Blu-ray standard.

The recording method is depicted on the basis of the following assumptions, which are only given to illustrate the method:

the recording device gets from the host system the command to write 16 data blocks to logical addresses 101 until 116;

the defect management area is from physical addresses 1001 until 1100;

the physical address on disc normally corresponding to logical address 110 is defective.

In these conditions, the recording method in accordance with this first embodiment first comprises a step of detecting DET (21) on the record carrier a defective location 110 at which a data block has to be written. The information about the location of defects is found in the defect management tables in case it was already known that a location was defective. Alternatively, this information is stored in so-called ‘defect lists’. New errors on the record carrier can be detected during the writing of information to that location by analyzing, for example, the tracking error signal or other control signals. Another option to determine defective locations is via a write-verify sequence, i.e. by writing data to disc and reading it back, to see if the writing and consecutive reading was successful.

In a second step MOV (22), the recording method is adapted to move the optical pick-up unit, i.e. the write head, of the recording device towards a predetermined track comprising a first location M=1010, for example, within the defect management area to which the at least one data block is planned to be written.

In a third step WOB (23), the recording method is able to determine a current location L=1003, for example, of the write head on the track. To this end, there is address information coded in a wobble that is on the optical rewritable disc. When the recording device has to read data from a certain address, it moves the optical pick-up unit to the corresponding track and starts reading there. From the wobble information it can determine the exact location, i.e. the physical address, it is reading.

In a fourth step W2 (24), the recording method is adapted to determine a second location J=1004, for example, which is the nearest available location (i.e. a location which contains no data or data that could be overwritten) on the track of the current location of the write head in the rotational sense of the record carrier. The recording method is then able to write the data block to the second location according to a principle known to a person skilled in the art.

It finally comprises a step UPD (25) of updating the table area. To this end, the recording device is adapted to create an entry stating that the logical address 110 can be found at physical address 1004 in the table area of the record carrier.

If necessary, i.e. if J=1004 is part of the user area, the recording method comprises a step of modifying the defect management area in such a way that the second location is part of said defect management area. This can be done by exchanging free part of the defect management area with the part of the user area that has been written. As an alternative, the recording method is adapted to determine and to write the data block to a second location, which is the nearest available location on the track of the current location of the write head in the rotational sense of the record carrier, and which is part of the defect management area. In this case, the recording method can tolerate a small rotational delay.

Thanks to such a recording method, the recording device can just pick the first free locations it happens to see under the optical pick-up unit when it has to write something in the defect management area. This is opposed to waiting for the predetermined physical address M to come under the optical pick-up unit, as described in the prior art, which could take almost an entire rotation.

It is to be noted that a number of conditions have to be fulfilled for a proper work of the invention. The first condition is that it should be possible to write the data to location J, that is location J should not already contain data that can't be lost. This can be known from the defect management tables. The second condition is that it should be made clear that the data which was meant to be written to address M is not at address M, but can be found at address J instead. This is done thanks to the update of the table area.

The principle described in FIG. 2 in the case of defect management can be generalized to the writing of any kind of data blocks. To this end, the recording method in accordance with a second embodiment of the invention comprises the following steps.

In a first step, the write head is moved towards a predetermined track comprising a first location M to which the at least one data block is planned to be written.

Then, in a second step, a current location L of the write head on the track is determined.

In a third step, a second location J, which is the nearest available location on the track of the current location of the write head in the rotational sense of the record carrier, is determined.

Finally, said at least one data block is written to said second location.

Let us illustrate this embodiment with the following example. The host system gives a command to write a certain amount of data, for example 64 logical blocks, to a physical address range starting at physical address M. The recording device then moves the optical pick-up unit towards the corresponding track, determines its position on the track by reading the wobble information, finds out that it can start writing almost immediately to physical address J=M+1 and that it has to wait almost a rotation to start writing to physical address M.

Thanks to the second embodiment of the present invention, the data that was initially meant to be written to physical addresses M until M+63 is going to be written to physical addresses M+1 until M+64. This is of course only allowed if physical address M+64 is available, i.e. free, to write data in (addresses M+1 until M+63 are of course available as it was already planned to write data to these locations).

However, in order to ensure a proper work of the invention, it has to be stored somewhere that the data blocks can't be found at physical address range M until M+63, but that they are stored at physical addresses M+1 until M+64. This can be done according to two different ways.

According to a first variant of this embodiment, the record carrier includes a user area for storing the data blocks and a table area for storing a correspondence between logical addresses of data blocks and their location in the user area, said table area being similar to the table area described in the first embodiment but having a greater size. The recording method then comprises the step of updating said table area on the basis of the second location, i.e. the correspondence or mapping between logical addresses and physical addresses M+1 until M+64.

Such a solution requires that the mapping of logical addresses to physical addresses is stored on the record carrier before said carrier is released and that other recording devices have to read and understand the updated table area as well.

According to a second variant of this embodiment, the recording method makes use of a file management system. The recording method then comprises the step of updating the file management system on the basis of the second location, i.e. the physical addresses M+1 until M+64.

Such a method is based on the presumption that the recording device is able to read or understand the file management system that is used on the record carrier, and that the recording device is able to update the file management system as well. In order to determine if physical address M+64 is free, the recording device is able to read or understand the file management system anyway, so only updating the file system is an extra requirement. By updating the file management system, the information about the second location of the data blocks is stored properly and the logical to physical mapping in the recording device can remain simple.

To make sure that the file management system in the host system is in line with what is on the record carrier, the recording device is able to update the information in the host system accordingly. This can be done by a drive initiated unmount—mount sequence, where the recording device has the opportunity to update the file management system on the record carrier after the unmount and before the mount sequence. Such a process is described, for example, in the not yet published patent application no 03101838.5 (attorney's docket: PHNL030757), which is here incorporated by reference. Alternatively, the recording device can keep track of all the changed addresses until a host initiates.

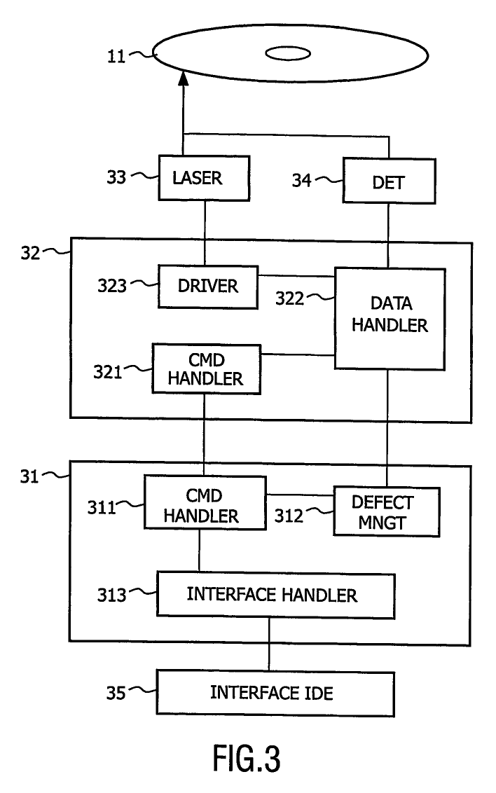

FIG. 3 shows a recording device for writing information on an optical disc of a type that is writable or re-writable, for example CD-R or CD-RW or DVD+R or DVD+RW or BD. The recording device is provided with recording means for scanning the track on the record carrier, which means include a drive unit for rotating the record carrier, a head, a positioning unit for coarsely positioning the head in the radial direction on the track and a control unit.

When the host system sends a command to write 10 data blocks to logical addresses k until k+9, the data and the command go from interfacing means 35 to a bit engine 32, via an interface handler 313 and a command handler 311 of a datapath 31. The function of the bit engine 32 is to control the laser 33 and to accept read and write commands (it is to be noted that the optical pick-up unit control has not been drawn in FIG. 3 for clarity purpose). The command is then handled by the command handler 321 in the bit engine 32. It is sent forward to the laser driver 323 via the data handler 322.

The recording device comprises a detector 34, which detects if there is an error when writing a data block. For example, let us assume that there is an error in writing data block 5 on the disc. This defect information is sent forward, via the data handler 322, to the defect manager 312 in the datapath 31. The defect manager 312 sends a new command to the bit engine 32 via the datapath command handler 311 to write data block 5 to one of the addresses in a range of addresses, said addresses laying in the defect management area and being still free. Another option is to send a list of free addresses in the defect management area. The bit engine 32 controls the optical pick-up unit to jump to the lowest of the addresses where data block 5 can be written. The bit engine then reads its location via the wobble in the disc. As the bit engine has determined its location on the disc, it writes data block 5 to the first address out of the range of the list that it receives. The address where data block 5 is written is then sent to the datapath 31 that can consequently update its defect management tables in the table area.

The recording method in accordance with the invention can be implemented by means of items of hardware or software, or both. Said hardware or software items can be implemented in several manners, such as by means of wired electronic circuits or by means of an integrated circuit that is suitable programmed, respectively. The integrated circuit comprises a set of instructions. Thus, said set of instructions contained, for example, in a memory may cause the integrated circuit to carry out the different steps of the recording method. The set of instructions may be loaded into the memory by reading a data carrier. A service provider can also make the set of instructions available via a communication network such as, for example, the Internet.

Any reference sign in the following claims should not be construed as limiting the claim. It will be obvious that the use of the verb “to comprise” and its conjugations do not exclude the presence of any other steps or elements besides those defined in any claim. The word “a” or “an” preceding an element or step does not exclude the presence of a plurality of such elements or steps.

1. A method for recording at least one data block on a disc-shaped record carrier, said method comprises the steps of:
moving a write head towards a predetermined track comprising a first location (M) to which the at least one data block is planned to be written,
determining a current location (I) of the write head on the track,
determining a second location (J), which is the nearest available location on the track of the current location of the write head in the rotational sense of the record carrier,
writing said at least one data block to said second location.

2. A method as claimed in claim 1, wherein said record carrier includes a user area for storing the data blocks, a defect management area for storing data blocks corresponding to defective locations in the user area and a table area for storing a correspondence between logical addresses of data blocks and their location in the defect management area, said method comprising the step of detecting on the record carrier a defective location to which a predetermined data block should have been written, the moving step being adapted to move the write head towards a predetermined track comprising a first location (M within the defect management area to which the predetermined data block is planned to be written, the method further comprising a step of updating the table area on the basis of the second location (J).

3. A method as claimed in claim 2, further comprising a step of modifying the defect management area in such a way that the second location belongs to the defect management area.

4. A method as claimed in claim 1, wherein said record carrier includes a file management system, said method further comprising the step of updating the file management system on the basis of the second location.

5. A method as claimed in claim 1, wherein said record carrier includes a user area for storing the data blocks and a table area for storing a correspondence between logical addresses of data blocks and their location in the user area, said method further comprising a step of updating the table area on the basis of the second location.

6. A device for recording data blocks on a disc-shaped record carrier, said device comprising:
a head for writing at least one data block on said record carrier,
means for moving the write head towards a predetermined track comprising a first location (M) to which the at least one data block is planned to be written,
means for determining a current location (I) of the write head when it is positioned on the predetermined track, and
means for controlling the write head in such a way that the at least one data block is written to a second location (J), which is the nearest available location on the track of the current location of the write head in the rotational sense of the record carrier.

7. A device as claimed in claim 6, wherein said record carrier includes a user area for storing the data blocks, a defect management area for storing data blocks corresponding to defective locations in the user area and a table area for storing a correspondence between logical addresses of data blocks and their location in the defect management area, said device comprising means for detecting on the record carrier a defective location to which a predetermined data block should have been written, the moving means being adapted to move the write head towards a predetermined track comprising a first location (M) within the defect management area to which the predetermined data block is planned to be written, said device further comprising means for updating the table area on the basis of the second location (J).

8. A device as claimed in claim 6, wherein said record carrier includes a file management system, said device further comprising means for updating the file management system on the basis of the second location.

9. A device as claimed in claim 6, wherein said record carrier includes a user area for storing the data blocks and a table area for storing a correspondence between logical addresses of data blocks and their location in the user area, said device further comprising means for updating the table area on the basis of the second location.

10. A computer program product comprising program instructions for implementing, when said program is executed by a processor, a method as claimed in claim 1.
